(19) United States
(12) Patent Application Publication
(10) Pub. No.: US 2014/0090778 A1
(43) Pub. Date: Apr. 3, 2014

(54) METHOD OF MANUFACTURING REVERSE-PRINTED, PRESSURE SENSITIVE CUT LABELS

(71) Applicant: Outlook Group Corp., Neenah, WI (US)

(72) Inventors: Tina M. Galoff, Brillion, WI (US); Pat Harvath, Neenah, WI (US); Todd Schuh, Combined Locks, WI (US)

(73) Assignee: Outlook Group Corp, Neenah, WI (US)

(21) Appl. No.: 14/041,109

(22) Filed: Sep. 30, 2013

Related U.S. Application Data
(60) Provisional application No. 61/708,633, filed on Oct. 1, 2012.

(51) Int. Cl. B32B 38/00

(52) U.S. Cl. CPC B32B 38/0004
USPC 156/256

(57) ABSTRACT

The present invention provides a method of producing a reverse-printed pressure-sensitive cut label using thin or lighter liners in a continuous process and single pass. The invention eliminates the need for printing over the adhesive or silicone and permits reverse printing directly on the backside of the label face stock. Further, the present invention obviates the need for shipment of finished label material to a printer for printing and eliminates the multiple steps and costly equipment involved in silicone coating release paper in-line during the label making process. In addition, the present invention provides a method of producing multiple, single webs of cut reverse-printed labels in a single pass, saving both materials costs and additional unwinding, slitting and rewinding steps and equipment.

### FIELD OF THE INVENTION

The present invention relates to a method and apparatus for making an adhesive-backed printed pressure sensitive label, wherein the portion of the label forming the label stock is printed on the backside and whereby the printed surface is coated with a hot melt adhesive. The label stock is then laminated to a base stock comprising a paper or polymeric release liner coated with silicone. The label stock and base stock are simultaneously fed to laminating rollers following a die-cutting process, whereby the two are joined.

### BACKGROUND OF THE INVENTION

U.S. Pat. No. 6,852,191 discloses a method and apparatus for making an adhesive-backed label whereby glassine paper stock is unwound from a roll, coated with photo-cationic silicone and cured using ultraviolet light to form a silicone-coated release paper. The means of applying silicone comprises a closed chambered doctor blade. Adhesive is applied over the cured silicone layer of the coated glassine paper, cooled using a first cooling roller, then fed with a face stock to a laminator and cooled with a second cooling roller.

U.S. Pat. No. 7,608,161 discloses a method and apparatus for making adhesive-backed labels whereby glassine paper stock is unwound from a roll, coated with photo-cationic silicone and exposed to a wavelength-controlled illumination to cure. Hot melt adhesive is applied over the silicone. Simultaneously, label stock is fed with the coated glassine paper to laminating rollers where the two are joined, and the label stock is cooled using a first cooling roller and then a second cooling roller downstream. Illumination to cure the silicone is provided by a dichroic reflector.

U.S. Publication No. 2005/0089662 discloses a method and apparatus for making adhesive-backed labels whereby glassine-coated paper is coated with silicone, the silicone is cured, and a hot melt adhesive is applied over the silicone layer. The glassine-coated paper is then laminated to a label face stock.

U.S. Pat. No. 7,556,708 discloses a method and apparatus that forms a cut label on a liner by feeding a web of lined label material to a cutting station (either a laser cutter or anvil roller and hammer die head cutter) to cut the label material, forming a matrix around the cut label and stabilizing the label edge without vacuum, stripping the cut label from the label material and applying labels to a substrate.

U.S. Pat. No. 7,815,761 discloses a method for forming a cut label on a liner by feeding a web of unlined label material having an adhesive face to a cutting station comprised of a chilled rotating die head with multiple raised cutting edges, cutting the label material to provide a matrix around the label, and stabilizing the label material with respect to the matrix without vacuum and feeding a web of liner to a set of rollers against the adhesive face of the label material.

U.S. Publication No. 2011/0036504 discloses a chilled rotating die head for cutting or perforating pressure-sensitive labels.

It is generally known in the art that printed labels with a pressure-sensitive adhesive backing are applied to containers for food products, health and beauty products, liquids, soaps, vitamins and other similar end-use products, among many others. The labels are made so as to require the removal of a liner, generally known as a “release liner.” A release liner may be made from coated or uncoated papers or polymeric films, and is typically coated with a silicone layer that enables the liner to release from the label before it is applied to a container. Removal of the release liner exposes the pressure-sensitive adhesive, permitting the label to adhere and be applied to the container with the application of slight pressure to create an adhesive bond between the label and container.

The term “pressure-sensitive adhesive,” as used herein, refers to an adhesive which adheres to a surface as a result of slight application of pressure, through any known means, as opposed to thermal activation, evaporation, or absorption of a solvent to form a solid bond.

Pressure-sensitive labels can be provided in many different formats, with the most significant being a format of label face stock made from a natural or synthetic fiber paper, polymeric film, metal foil or combinations of these materials, a pressure-sensitive adhesive, and a release liner in contact with the adhesive. These three components—label face stock, pressure-sensitive adhesive and release liner—are referred to herein as “label stock material.” Labels are made using label stock material and cutting the label face stock by cutting or micro-perforating the shape of the label, by known means, e.g., a laser cutter, an anvil roller and die head cutter or other cutting method, into the label stock material, leaving a remainder portion of the label material around the cut label shape called the matrix. The matrix is removed leaving the labels attached to the release liner and either rolled in multiple label widths into a web or separated and slit into single label width webs.

The most typical format of a pressure-sensitive label comprises a laminated combination of a printed face stock that is printed on the top surface (opposite the surface to which adhesive is applied) and covered with an over-print varnish to prevent ink rub-off; a pressure-sensitive adhesive on the back or reverse side of the face stock; and a silicone layer and backing paper liner to which the silicone layer is relatively strongly adhered. The face stock can be transparent or opaque. Opaque face stock can be pre-printed on both sides, for instance, when a label is applied to a transparent container such as a plastic or glass bottle and is filled with a relatively transparent liquid, such as detergent or soap. The printing on the back- or reverse-side of the label face stock can then be read through the container and the product contained therein. Transparent face stock usually is printed only on the front- or surface-side of the label, with the ink covered by a layer of protective varnish.

The traditional adhesive used in a pressure-sensitive label is water-based, requiring a relatively long air drying time. The release liner most typically used is a glassine paper coated with silicone to produce a suitable release effect between the label face stock and the release liner when the label is applied to a container or other surface. The prior art method of manufacturing pressure-sensitive labels with silicone coated release liner involves numerous steps and has many drawbacks. First, the roll of glassine paper has to be hung and unwound to apply silicone. The curing process involves relatively large equipment with controlled humidity and temperatures. Second, the cured release paper is then rewound and hung on a second lamination machine where adhesive is applied to the paper and hung in a lengthy 200-foot air drying structure to adequately cure. After curing, the adhesive coated release paper is rehung on a second lamination station to marry the release paper to a printable label face stock. Following this manufacturing process, a printer unwinds the roll of label stock material to print the label face stock.

This label manufacturing process is cumbersome, involves multiple steps, large equipment, and numerous lamination steps followed by a final printing step. Moreover, the prior art makes it unworkable to print on the back or reverse side of the label face stock to which the adhesive is strongly bonded. In the event of a label stock material that is desired to be printed on the back side of the label face stock, the prior art makes it necessary to strip the label face stock from the liner, print on the backside of the label face stock, and then re-laminate the face stock to the liner. The prior art in such reverse-side label printing is cumbersome and involves multiple re-lamination, printing, and de-lamination steps. Further, the prior art makes rework at the time of label application difficult because of the adherence of ink to the adhesive and the container surface to which the label initially was applied. Moreover, when reverse-side printing is desired, the label face stock must be de-laminated from the release liner and printing is typically done over the adhesive. The result is blurry printing and limited graphics in order to avoid deadening of the adhesive.

U.S. Pat. No. 6,852,191 (the '191 Patent) and U.S. Pat. No. 7,608,161 (the '161 Patent) (collectively the “Bayzelon Patents”) attempt to improve upon the prior art by eliminating the need for multiple lamination passes, long silicone and adhesive curing times, and the associated unwinding and rewinding processes. The Bayzelon Patents disclosed a method of manufacturing pressure-sensitive adhesive label stocks with back side printing whereby glassine paper release stock is unwound from a roll, coated with a fast-curing, photo-cationic silicone, and exposed to wavelength-controlled ultra-violet illumination to cure. Illumination is provided by a dichroic reflector. A hot melt adhesive is applied over the silicone layer on the release paper and cooled using a cooling roller. Simultaneously, label stock is fed with the coated glassine paper to laminating rollers where the two are joined and the label stock material is further cooled using a second downstream cooling roller. An advantage of the Bayzelon Patents is that the label face stock can be reverse printed on the back side before the label face stock and release paper are laminated, eliminating the need for a subsequent de-lamination and re-lamination of the label face stock from and to the liner downstream in the overall process. Because printing is not done over the adhesive, the Bayzelon Patents eliminate the likelihood of blurred printing on the reverse side of the label face stock. Further, the Bayzelon Patents obviate the need for lengthy equipment to cure the silicone release liner and provide an apparatus that essentially produces a web of labels in multiple label widths married to a release liner in a single pass.

U.S. Pat. No. 7,556,708 (the '708 Patent) discloses a method of forming a cut label on a liner by feeding completed, label stock material (a label face stock laminated to a release liner) into a station that de-laminates the face stock from the release liner, cuts label material, and then re-laminates the label face stock to the release liner, forming a web of multiple widths of cut labels. The '708 Patent process also enables the manufacturing of liner-less labels to be used in liner-less label application equipment by re-laminating the label face stock to a temporary, or carrier, liner that is easily removed by such application equipment. This de-lamination and re-lamination process is cumbersome, time-consuming and inefficient with respect to the process of the current invention. Further the '708 Patent does not teach a method of enabling reverse printing on the back side of the label face stock.

U.S. Pat. No. 7,815,761 (the '761 Patent) teaches a method of creating liner-less labels by using a temporary, or carrier liner, or labels with thin liners. The '761 Patent eliminates the de-lamination and re-lamination steps in the label cutting process of the '708 Patent by disclosing a cutting method that involves a rotating chilled die cutting head to cut the completed label stock material (face stock laminated to release liner) to provide a matrix around the label shape. The '761 Patent process uses a chilled die cutting roller that is chilled to a temperature at or below the glass transition temperature (Tg) of the adhesive (which reduces or eliminates the tackiness of the adhesive) that adheres the label face stock to the liner. The chilled die cutting method cuts through the label face stock easily without slicing through to the liner. The '761 Patent also discloses the preferred embodiment of the die cutting of liner-less labels with an exposed adhesive surface by use of the chilled die cutting roller chilled to the Tg of the adhesive. The liner-less labels are laminated to a temporary, or carrier or sacrificial liner prior to die-cutting, so that they can be used in conventional label application equipment. The '761 Patent also teaches a method where a carrier or sacrificial liner is used prior to die cutting, a vacuum is used to remove or de-laminate the carrier or sacrificial liner, and then the face stock is laminated to a final liner after die cutting, enabling the use of thinner liners. Temporary, sacrificial or carrier liners may be re-used a limited number of times. After cutting the label shapes in accordance with the '761 Patent process, the label is stabilized with respect to the matrix without the use of vacuum. The avoidance of vacuum securement is advantageous with the use of thinner liners which may be more readily deformed than would thicker, heavier release liners. U.S. Publication No. 2011/0036504 describes an improved cooled die head over that taught in the '761 Patent for cutting or perforating label materials.

Like the '708 Patent, the '761 Patent does not teach a method that enables reverse printing of the label face stock. The present invention improves and streamlines the label-making process by die cutting reverse printed label face stock (with exposed adhesive) immediately prior to laminating the face stock to a release liner, eliminating the need for stabilization using mechanical means as called out in the '761 Patent. Further, the present invention teaches a method that has a continuous process of stripping the matrix around the label and a continuous label-making process, which the prior art does not possess. Reuse of sacrificial or temporary liners decreases efficiencies because it requires that the label-making process be stopped so that the temporary liners can be rewound and rehung on the label machine to be reused during the label-making process. Sacrificial liners can only be used a limited number of times, creating a need of additional liner material that ultimately ends up as waste during the label making process. The '761 Patent process is not a continuous process of label-making and stripping of the matrix around the label, as taught by the present invention.

As in the Bayzelon Patents as well as the '708 and '761 Patents, it is necessary to remove webs of multiple-width cut labels to secondary unwinding, slitting, and rewinding equipment to produce webs of single-width cut labels. The use of these secondary processes introduces higher costs as well as greater waste of materials. None of the prior art teaches a method of continuous reverse-printed label-making, as in the present invention, that results in multiple finished single-width label webs.

### SUMMARY OF THE INVENTION

The present invention improves upon the prior art by providing a method of producing a reverse-printed pressure-sensitive cut label using thin or lighter liners in a continuous process and single pass. The invention eliminates the need for printing over the adhesive or silicone and permits reverse printing directly on the backside of the label face stock. Further, the present invention obviates the need for shipment of finished label material to a printer for printing and eliminates the multiple steps and costly equipment involved in silicone coating release paper in-line during the label making process. In addition, the present invention improves upon the prior art by providing a method of producing multiple, single webs of cut reverse-printed labels in a single pass, saving both materials costs and additional unwinding, slitting and rewinding steps and equipment. The present invention also improves upon the prior art by eliminating de-lamination and re-lamination steps or the disruption of the label-making process by use of a temporary, carrier or sacrificial liner, as taught in the '761 Patent.

A unique feature of the present invention enables the reverse-printing of transparent film or opaque label face stock and marriage of the face stock with a pre-siliconized, lightweight polymeric film or paper release liner. Another unique element of the present invention provides a method of maintaining a minimal, consistent coat weight of adhesive applied to the back of the label face stock, providing ink adhesion to the back of the label face stock and enhancing the removability and repositioning of labels as necessary in the label application process. It is novel feature of the present invention to pre-print or, in one embodiment, to print in-line, on the reverse-side of a thin polymeric film or opaque label polymeric film, foil or paper (or combinations thereof) face stock, apply adhesive to the reverse side of the label face stock over the ink (eliminating the need for any UV or over-print varnish of surface-printed labels), cutting a web of multiple label widths to provide a removable matrix, laminating the label face stock to a pre-silicone-coated polymeric film or paper liner, removing the matrix in a continuous process, and slitting the web of multiple label widths into single rolls of finished label materials. It is further unique to this invention to pre-print white ink on the reverse-side of a thin polymeric film label face stock to create an opaque, reverse-printed label with the appearance of a paper label stock. The opaque surface enables the printing of improved, full cover graphics on the back of the label over the white ink. The advantage of the invention as opposed to paper labels or other reverse printed labels of the prior art is the assurance of ink adhesion to the back of the label face stock in the event of short-term repositioning once the label is adhered to a container surface. The present invention also improves upon the prior art wherein the label face stock is printed over the adhesive surface, which is uneven and limits the quality, type and amount of graphics that can be printed on the back of a label. The invention enables full cover graphics that can easily be read on the back of a label face and eliminates a secondary material, such as a US varnish or film, to prevent ink pick-off from the typical surface-printed label face stock. The present invention is further superior to printing on the adhesive surface applied to the label face stock because printing over adhesive limits the amount of graphics that can be printed to avoid deadening of the adhesive, since too much ink would eliminate the adhesive characteristics of the label.

A further unique element for the practice of the present invention comprises a means for reducing the amount of work that has to be performed in a single line and a means for eliminating the separating of work onto different lines and even different locations, which reduces waste and cross-contamination of materials. Further, the single-pass operation of the present invention enables line speeds of up to 500 feet per minute (fpm) to produce single label-width webs of reverse-printed cut pressure-sensitive labels to be shipped directly to businesses involved in label application. An additional feature of this invention is the real-time weighing and calibration of adhesive as it is applied so as to maintain a minimal waste level of adhesive and a consistent application across the web. The unique aspect of applying a minimal, consistent adhesive coat weight also reduces finished label waste at the applicators' facilities because of the ease of removability and re-positioning of the labels. Further, using the present invention, label manufacturers print the face stock and produce the laminated label stock material rather than buying a more costly prefabricated laminated product and subsequently printing on the face stock. An additional benefit of the present invention is achieved when a clear label face stock is reverse printed prior to lamination to the release liner, because the print is then protected by the polymeric film face stock. When the label is applied to a container, the print on the back-side of the label face stock is protected by the film label face itself, eliminating the use of an additional UV varnish, UV glued film or pressure-sensitive film typical of the prior art surface-printed label stock.

Cost savings to label makers are further generated by a reduction of waste due to the fact that only the label face stock is printed. Additional savings occur when the printing occurs, as with one embodiment of the invention in-line as part of the label-making process itself. Moreover, there are no limitations on the printing methods, which can be flexographic, offset, rotogravure, digital, letterpress, silk screen, etc.

Further and additional features of the present invention will be described in the following detailed description which is to be read in conjunction with the accompanying drawings.

### BRIEF DESCRIPTION OF THE DRAWINGS

FIG. 1 is a drawing depicting the label stock material with a reverse-printed label face stock.

FIG. 2 is a drawing depicting the label stock material with a surface-printed label face stock.

### DESCRIPTION OF THE PREFERRED EMBODIMENTS

The present invention relates to a method of producing reverse-printed, pressure-sensitive cut adhesive labels in a single pass and may include and use any label face stock material, whether on paper bases (both natural fiber paper and synthetic fiber paper or combinations thereof), polymeric film, metal foil, and combinations of these materials. The release liner portion of the invention may include and use any natural or synthetic paper fiber stock or polymeric film, or combinations thereof, pre-coated with a pressure-sensitive silicone layer. The label face stock may be printed in-line or on a secondary line and the reverse-printed label stock fed into the process using any known unwind mechanism and then conveyed to the adhesive coating station. The label face stock may be printed on only the reverse side, only the surface, or on both sides of the label face stock. The printing method can be flexographic, rotogravure, offset, letterpress, digital, silkscreen, or other means that permit label removability following application to the surface of a container with 100% adhesion of ink to the label when or after the label is removed from the container surface for the purpose of rework or repositioning. A unique feature of a preferred embodiment of the invention is easy removability of the labels following application to the surface of a container in the event that repositioning or rework is needed, with no ink adhering to the container surface or being picked off the label. A further unique feature of the invention is that a polymeric film can be reverse-printed with full cover white ink to provide the appearance of a paper label and then full cover graphics may be printed over the white ink to provide a reverse-printed label with enhanced appearance and no need for an over-print varnish, UV glue or adhesive, or film to protect ink rub-off. The present method also enables easy removability of a label after application to a container surface with full ink adhesion to the label face stock.

U.S. Pat. Nos. 6,852,191 and 7,608,191 (the “Bayzelon Patents”) disclose a method of producing reverse-printed, pressure sensitive cut labels. Unlike the present invention, the Bayzelon Patents contemplate the use of pre-printed label face stock and teach a method of silicone coating the release liner in-line, curing the silicone, and then applying a layer of hot melt adhesive over the cured silicone layer on the release liner. In contrast, the present invention teaches a method of directly printing the reverse side of the label face stock and applying adhesive over the print using inks that enable 100% adhesion to the label if removed for rework or relocation during or following the application of the label to a container surface. Further, because practice of the present invention uses a pre-siliconized release liner, the invention improves upon the Bayzelon Patents by allowing for increased efficiencies due to a complicated silicone coating and curing time and related costly equipment such as a UV curing system. Moreover, the present invention allows for less waste due to the use of pre-siliconized release liner and further enhanced efficiencies when using pre-printed label face stock or, as in one embodiment printing in-line in a single pass as part of the label making process. Finally, the Bayzelon Patents disclose a method that produces a web of multiple finished label widths, requiring removal of the webs to a separate slitting and rewinding operation. In contrast, the present invention improves the prior art by slitting the web of multiple finished label widths in-line into single finished label width rolls, eliminating the need for secondary slitting and rewinding equipment and enhancing cost efficiencies by producing single finished label width rolls in-line. The present invention lowers the cost of finished labels by eliminating additional slitting and rewinding processes and auxiliary equipment time and operation.

U.S. Pat. No. 7,556,708 (the '708 Patent) discloses a method of producing labels from laminated label material by de-laminating the face stock from the release liner, cutting the labels, then re-laminating the face stock and release liner using adhesive. This method is costly and inefficient, involving a cumbersome de-lamination and re-lamination process that results in a potential for significant waste. Furthermore, the cutting mechanism, unlike the present invention, does not teach a method of chilling the die head and is likely to result in gumming up of the cutting edges with adhesive, resulting in significant downtime due to clogged tooling. Moreover, unlike the present invention, the '708 Patent does not disclose a method of producing individual webs of finished single label width rolls and requires additional equipment, time and inefficiencies to slit multiple label width webs into individual label webs.

U.S. Pat. No. 7,815,761 (the '761 Patent) discloses a method for forming a cut label using a chilled die head and stabilizing the cut labels without vacuum. In contrast to the '761 Patent, the present invention stabilizes the cut labels using micro-bridging or micro-perforation around the label edges and can be done with or without vacuum. Furthermore, the '761 Patent teaches a method of cutting a liner attached to a carrier or sacrificial liner, removing the sacrificial or carrier liner after die cutting, and re-laminating the face stock to a permanent liner. Again, the de-lamination and re-lamination process decreases efficiencies and line speeds and creates an increased opportunity for waste. Moreover, the use of a sacrificial or carrier liner requires that the label-making process be shut down so that the sacrificial or carrier liner can be rewound and rehung for use in the die-cutting process. The present invention eliminates this cumbersome and waste-producing process by die-cutting the label face stock through the exposed adhesive and immediately and laminating the face stock to a pre-siliconized release liner. Furthermore, neither the '708 nor '761 Patents enable reverse-printing of the label face stock as does the present invention, which teaches a method of full cover, enhanced graphics directly to the back side of the label face stock in a single-pass label-making process. Moreover, the '761 Patent does not teach a method of creating single label-width webs of finished label material; rather, secondary slitting and rewinding operations are required, decreasing efficiencies and increasing costs of production and opportunities for waste. In addition, the '761 Patent contemplates a module that can be attached to an existing lined label applicator machine; in contrast, the present invention results in single label width webs of finished labels to be shipped directly to label applicators. Finally, the '761 Patent describes a method of stabilization of the cut labels with respect to the matrix without the use of vacuum. The present invention can stabilize the cut label using micro-bridging or micro-perforating around the label shapes, and stabilization can be done with or without vacuum.

The present invention contemplates a method of pre-printing the reverse side of the label faces stock or printing in-line as part of the label making process, or printing both sides of the label stock. Printing can be done by any known means using commercially available UV, flexographic, or other inks which result in complete adhesion of ink to the label surface (with 0% adhering to the container surface) following removability within a short time period after application of the label to a container surface. A preferred embodiment of the invention results in 100% ink adhesion to the label face stock following a base line of testing within 5 and 60 minutes of application of the label to a clear plastic bottle surface. Testing for ink adhesion can be accomplished by use of a Thwing Albert Model 225-1 (or similar) peel-testing unit, which is designed to test and measure label peel strength and convert into several different units of measure utilizing a calibrated load cell and a mechanically repeatable motor/pulley system. Data is retained and recorded on a printout. With respect to the present invention, the speed parameters used for testing ink adhesion using the Thwing Albert Model 225-1 peel-testing unit were 12 inches per minute with a 3 second pre-peel (window of time prior to load cell taking live data). The unit of measure was grams and the total test time was 9 seconds (minus the pre-peel). Each label sample was cut into a 1-inch strip and was 5 inches in length. The sample strips were applied to flat strips cut from a clear polyester (PET) bottle. Samples were tested initially after 5 minutes and again at 60 minutes. Results of the tests were recorded along with a percentage of ink that was visibly observed remaining on the PET test bottle to which the labels were applied. Test data and results are summarized below:

TABLE 1

| Ink/Label face stock/Adhesive | Ink Adhesion/5 minutes | Ink Adhesion/60 min |
|---|---|---|
| Sample 1 Flexo water-based ink | 0% | 0% |
| Solvent primed BOPP | (1200-1800 gms peel force) | (1000-1600 gms peel force) |
| Clear on Clear Adhesive | | |
| Sample 1 water based ink | 0% | 0% |
| Acrylic coated BOPP | (1300-1700 gms peel force) | (1100-1800 gms peel force) |
| Clear on Clear Adhesive | | |
| Sample 2 UVF ink | 0% | 0% |
| Solvent Primed BOPP | (900-1200 gms peel force) | (1100-1400 gms peel force) |
| Clear on Clear Adhesive | | |
| Sample 2 UVF Ink | 0% | 0% |
| Acrylic Coated BOPP | (850-1200 gms peel force) | (1400-1500 gms peel force) |
| Clear on Clear Adhesive | | |
| Sample 3 UVF Ink | 0% | 0% |
| Acrylic coated BOPP | (1400-1800 gms peel force) | (1100-1400 gms peel force) |
| Clear on Clear Adhesive | | |
| Sample 1 water-based | 0% | 0% |
| Solvent Primed BOPP | (700-1200 gms peel force) | (1100-1300 gms peel force) |
| Paper Grade Adhesive | | |
| Sample 1 water-based | 0% | 0% |
| Acrylic coated BOPP | (1100-1300 gms peel force) | (1100-1300 gms peel force) |
| Paper Grade Adhesive | | |
| Sample 2 UVF ink | 0% | 0% |
| Solvent Primed BOPP | (1100-1300 gms peel force) | (1200-1300 gms peel force) |
| Paper Grade Adhesive | | |
| Sample 2 UVF ink | 0% | 0% |
| Acrylic Coated BOPP | (800-1200 gms peel force) | (1100-1200 gms peel force) |
| Paper Grade Adhesive | | |
| Sample 3 UVF ink | 0% | 0% |
| Acrylic Coated BOPP | (800-1200 gms peel force) | (1300-1400 gms peel force) |
| Paper Grade Adhesive | | |
| Sample 1 water-based ink | 0% | 0% |
| Solvent Primed BOPP | (1300-1500 gms peel force) | (1400-1500 gms peel force) |
| Food Grade Adhesive | | |
| Sample 1 water-based ink | 0% | 0% |
| Acrylic Coated BOPP | (1100-1500 gms peel force) | (1200-1500 gms peel force) |
| Food Grade Adhesive | | |
| Sample 2 UVF ink | 0% | 0% |
| Solvent Primed BOPP | (1000-1400 gms peel force) | (1300-1600 gms peel force) |
| Food Grade Adhesive | | |
| Sample 2 UVF ink | 0% | 0% |
| Acrylic Coated BOPP | (1100-1500 gms peel force) | (1100-1500 gms peel force) |
| Food Grade Adhesive | | |
| Sample 3 UVF ink | 0% | 0% |
| Solvent Primed BOPP | (600-1300 gms peel force) | (1200-1300 gms peel force) |
| Food Grade Adhesive | | |
| Sample 1 water-based ink | 0% | 0% |
| Solvent Primed BOPP | (1000-1400 gms peel force) | (900-1200 gms peel force) |
| Short-term removability adhesive | | |
| Sample 1 water-based ink | 0% | 0% |
| Acrylic Coated BOPP | (900-1200 gms peel force) | (1000-1200 gms peel force) |
| Short-term removability adhesive | | |
| Sample 2 UVF ink | 0% | 0% |
| Solvent Primed BOPP | (600-800 gms peel force) | (750-950 gms peel force) |
| Short-term removability adhesive | | |
| Sample 2 UVF Ink | 0% | 0% |
| Acrylic Coated BOPP | (700-800 gms peel force) | (800-1100 gms peel force) |
| Short-term removability adhesive | | |
| Sample 3 UVF ink | 0% | 0% |
| Acrylic Coated BOPP | (600-900 gms peel force) | (750-900 gms peel force) |
| Short-term removability adhesive | | |

The basic steps of a preferred method of producing the reverse-printed, pressure-sensitive labels are described as follows: A label face stock comprising a clear, 100-300 gauge biaxially oriented polypropylene (BOPP) film top-coated with an acrylic coating or pre-primed with a solvent primer is printed over the acrylic coating or solvent primer on the reverse side of the label face stock using a reverse flexographic printing process. The printing is performed on a separate line and fed into the label making apparatus, or printed in-line with the label making apparatus, using a turning apparatus or other known method to feed the printed web into such apparatus at a first work station. The desirability of this invention is that printing also may be performed using rotogravure, offset, letterpress, digital, silk screen or other printing methods that would enable the label to achieve 100% adhesion to the label face stock and allow short-term removability following application of the label to a container surface. Short-term removability is desirable by label applicators and reduces waste in the event that rework is necessitated. A preferred ink is either water-based or UVF Flexo ink, such as those commercially available and produced by ink manufacturers. The label face stock may also include natural or synthetic papers, polymeric films, metal foils and combinations thereof. The label face stock may be printed on the top surface of the label face, the reverse surface of the label face, or both surfaces for application as pressure sensitive labels.

At a second work station, a consistent weight of hot melt adhesive is applied across the web using a rotary application method, rod application method, an adhesive slot die coater or other known means of applying hot melt adhesive. The adhesive is evenly and consistently applied across the web, calibrated in real-time using an infrared scanner. A desired adhesive coat weight is between 10 and 25 grams per square meter. The applicator applies the adhesive over the ink on the reverse side of the label face stock before entering the third work station, the cutting mechanism used to cut label shapes.

A preferred method of cutting labels uses a chilled die head cutter with multiple cutting edges and a steel roll to either clean-cut label shapes, micro-bridge, or micro-perforate the edges of labels as a means of stabilizing the label with or without vacuum. Label shapes are cut through the exposed adhesive on the reverse side of the label face stock. Micro-bridging comprises cutting the label face stock on the exposed adhesive side with two or more small sections of the label not cut through, leaving such micro-sections attached to the matrix surrounding the cut label shapes. Micro-perforated labels comprise a label shape perforated around the edges rather than clean-cut through the face stock. The die cutting tool preferred is a chilled die head with multiple cutting edges that has an inner chamber through which a coolant liquid is circulated. The die head is cooled at or below the glass transition temperature (Tg) of the adhesive used.

At a fourth work station, the web of cut label shapes on the label face stock is conveyed to a laminator into which a release liner is simultaneously fed. The preferred release liner is a 40-120 gauge polyester film (PET) pre-coated with an adequate layer of silicone to permit the requisite release of the label from the liner during the application process. Alternative release liners can be pre-siliconized polymeric films, papers (natural or synthetic fibers), or combinations thereof. The label face stock is laminated to the release liner using one or more nip rollers such that the reverse-printed face stock layer is adjacent to the silicone-coated layer of the release liner. Preferred adhesives can be those commercially available and used typically in food grade applications, paper applications, clear to clear film applications or short-term removability applications. Lamination of the label face stock and the release liner forms a continuous, multiple label-width web of reverse printed labels on liner. Lamination occurs immediately after the die cutting operation, eliminating the need for vacuum stabilization; however, vacuum stabilization may be practiced as part of the invention as well. The matrix surrounding the label shapes is then removed using a known vacuum method or rewinding the matrix on a roll.

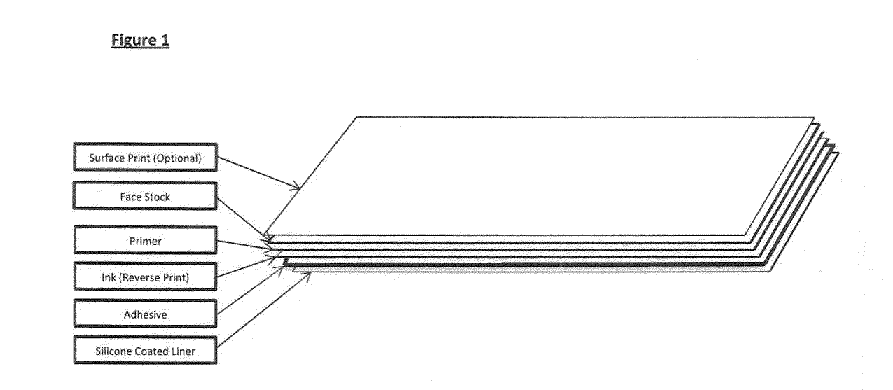

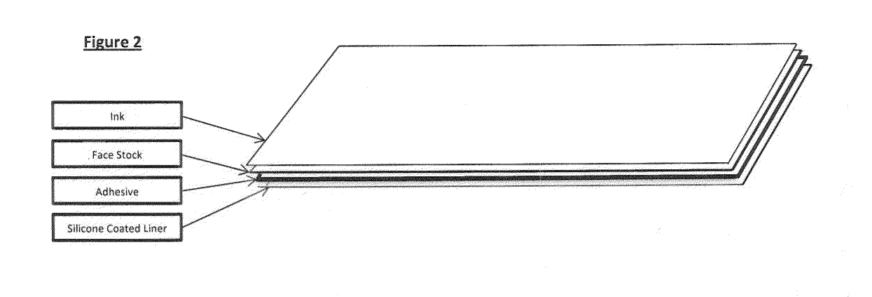

At a final work station, immediately after removal of the matrix, the multiple-label width web is then slit into multiple single label-width webs using generally known slitting methods. After slitting into the desired widths, the final product is rewound into rolls of single label widths. Exemplary products are shown in FIG. 1 (label stock material with a reverse-printed label face stock) and FIG. 2 (label stock material with a surface-printed label face stock).

Patents and patent applications referred to herein are hereby incorporated by reference in their entireties. Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method of making continuous webs of cut reverse-printed pressure-sensitive adhesive labels on liner comprising the steps of:
(a) unwinding a web of label face stock in a stock processing machine having multiple work stations spaced to receive and process moving stock;
(b) at a first work station, unwinding pre-printed label face stock that is printed on the back or reverse side of the label face stock, or both the back and surface sides, with multiple widths of labels across the web,;
(c) at a second work station, unwinding the printed label face stock and applying a layer of adhesive over the printed ink on the reverse side of the label face stock;
(d) at a third work station, cutting label shapes across the web of adhesive-coated face stock through the exposed adhesive side of the label face stock to provide a matrix around the edges of the label shapes;
(e) from a second feed-in location located downstream from the cutting station, unwinding and feeding a continuous web of release liner stock that is pre-coated on at least one side with silicone and, at a fourth work station, laminating the label face stock and the release liner stock by passing both webs simultaneously through one or more nip rollers, whereby the adhesive-coated reverse side of the printed face stock is adjacent to the silicone-coated side of the release liner, to form a continuous web of laminated label material with multiple label widths across the web;
(f) at a fifth work station, removing the matrix around the label shapes to leave a continuous web of cut labels on release liner; and
(g) at a sixth work station, slitting the web of multiple-width cut labels on release liner, using multiple slitter stations, into individual continuous webs of single cut labels and rewinding the individual webs of cut labels on release liner.

2. The method of claim 1, wherein the ink used allows short-term removability of a label after being applied to a surface of a container with 100% adhesion of ink to the label when the label is removed from the container surface after a short time period following application;

3. The method of claim 1, wherein the ink is water-based;

4. The method of claim 1, wherein the ink is UVF (ultraviolet flexographic) ink.

5. The method of claim 1, wherein the ink is flexographic, water-based or UV ink.

6. The method of claim 1, wherein printing may be by flexographic, rotogravure, digital, offset, letterpress, silkscreen, or other means that permits label removability following application to the surface of a container, with 100% adhesion of ink to the label when the label is removed from the container surface following application.

7. The method of claim 1, wherein the top side or surface of the label face stock is printed, the back or reverse side of the label face stock is printed, or both the surface and reverse sides of the label stock are printed;

8. The method of claim 1, wherein the label face stock is 100 to 360 gauge biaxially oriented polypropylene (BOPP) top-coated with acrylic on the reverse side of the label face stock.

9. The method of claim 1, wherein the label face stock is 100 to 360 gauge BOPP primed with a solvent primer and treated with a Corona treater on the reverse side of the label face stock.

10. The method of claim 1, wherein the label face stock is natural or synthetic fibered paper or combinations thereof.

11. The method of claim 1, wherein the label face stock is polymeric film or metal foil or combinations thereof.

12. The method of claim 1, wherein the reverse-side of a polymeric film label face stock is printed with full coverage of white ink and then full coverage graphics are printed over the white ink.

13. The method of claim 12, wherein the front surface of the polymeric film label face may be printed and/or covered with a varnish, glue, or other film material.

14. The method of claim 1, wherein the adhesive used is a hot melt adhesive.

15. The method of claim 14, wherein the adhesive has no adhesive pick-off and 100% ink adhesion to the label face stock following removal from the container surface after label application suitable to a desired end-use application.

16. The method of claim 14, wherein the application of adhesive is continuously weighed and calibrated in real-time using an infrared scanner.

17. The method of claim 14, wherein the desired coat adhesive weight is between 10 and 25 grams per square meter.

18. The method of claim 1, wherein the label shapes are cut using an anvil steel roll and a chilled die head with multiple cutting edges.

19. The method of claim 18, wherein the chilled die head contains an inner chamber filled with liquid coolant that cools the cutting edges thereon to a temperature at or below the glass transition temperature of the adhesive used to laminate the label face stock and release liner.

20. The method of claim 18, wherein the die head is cooled to a temperature effective to cut through the adhesive layer of the label face stock without clogging the cutting edges of the die head.
